(19) United States
(12) Patent Application Publication
(10) Pub. No.: US 2025/0391129 A1
(43) Pub. Date: Dec. 25, 2025

(54) IMAGE PROCESSING APPARATUS AND METHOD, IMAGE CAPTURING APPARATUS, AND STORAGE MEDIUM

(71) Applicant: CANON KABUSHIKI KAISHA, Tokyo (JP)

(72) Inventors: AKITAKA YOSHIZAWA, Kanagawa (JP); SHUMA YOKOYAMA, Kanagawa (JP); KIYOSHI SEKIGUCHI, Kanagawa (JP); YUZO MATSUI, Kanagawa (JP)

(21) Appl. No.: 19/237,773

(22) Filed: Jun. 13, 2025

(30) Foreign Application Priority Data
Jun. 25, 2024 (JP) 2024-102222

(51) Int. Cl. G06T 19/00; G06T 7/521; G06T 7/70; G06V 20/10; G06V 20/20

(52) U.S. Cl. CPC G06T 19/006; G06T 7/521; G06T 7/70; G06V 20/10; G06V 20/20; G06T 2207/20081; G06T 2207/30192; G06T 2210/61

(57) ABSTRACT

An image processing apparatus comprises: an acquisition unit that acquires scene information of a scene being captured by an image capturing unit; a generation unit that generates a virtual subject; a processing unit that processes the virtual subject based on the scene information; and a superimposing unit that superimposes the virtual subject processed by the processing unit onto image data of the scene obtained from the image capturing unit.

### BACKGROUND

### Field of the Technology

The present disclosure relates to an image processing apparatus and method, an image capturing apparatus, and a storage medium, and more particularly to a technique for superimposing a virtual subject on a captured image.

### Description of the Related Art

As one of shooting techniques, it is known to superimpose a virtual subject on an image captured by a camera and use the superimposed image to consider shooting conditions even in a case where a real subject is not present. However, if a virtual subject is simply superimposed on a captured image, the real lighting conditions are not reflected on the virtual subject, resulting in an unnatural superimposed image.

In response to this, Japanese Patent Laid-Open No. 2009-163610 discloses a technique for reflecting real light source information on a virtual subject in order to fill in the gap in the lighting conditions between the superimposed virtual subject and the captured image.

However, although the technology described in Japanese Patent Laid Open No. 2009-163610 can fill the gap between the lighting conditions of the captured image and the virtual subject, it is silent about reflecting real weather information or terrain information to the virtual subject. As a result, in some cases, unnatural superimposed images are generated, and it is not possible to generate live view images that can be used for appropriately considering the shooting conditions.

### SUMMARY

The present disclosure has been made in consideration of the above situation, and a virtual subject that is more consistent with the situation in a captured image is superimposed.

According to the present disclosure, provided is an image processing apparatus comprising one or more processors and/or circuitry which function as: an acquisition unit that acquires scene information of a scene being captured by an image capturing unit; a generation unit that generates a virtual subject; a processing unit that processes the virtual subject based on the scene information; and a superimposing unit that superimposes the virtual subject processed by the processing unit onto image data of the scene obtained from the image capturing unit.

Further, according to the present disclosure, provided is an image capturing apparatus comprising: an image processing apparatus comprising one or more processors and/or circuitry which function as: an acquisition unit that acquires scene information of a scene being captured by an image capturing unit; a generation unit that generates a virtual subject; a processing unit that processes the virtual subject based on the scene information; and a superimposing unit that superimposes the virtual subject processed by the processing unit onto image data of the scene obtained from the image capturing unit; and the image capturing unit.

Furthermore, according to the present disclosure, provided is an image processing method comprising: acquiring scene information of a scene being captured by an image capturing unit; generating a virtual subject; processing the virtual subject based on the scene information; and superimposing the processed virtual subject onto image data of the scene obtained from the image capturing unit.

Further, according to the present disclosure, provided is a non-transitory computer-readable storage medium, the storage medium storing a program that is executable by the computer, wherein the program includes program code for causing the computer to function as an image processing apparatus comprising: an acquisition unit that acquires scene information of a scene being captured by an image capturing unit; a generation unit that generates a virtual subject; a processing unit that processes the virtual subject based on the scene information; and a superimposing unit that superimposes the virtual subject processed by the processing unit onto image data of the scene obtained from the image capturing unit.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating a functional configuration of an image capturing apparatus according to a first embodiment of the present disclosure.

FIGS. 2A to 2C are conceptual diagrams illustrating an acquisition method of spatial information according to the first embodiment.

FIGS. 3A and 3B are conceptual diagrams of a generation method of a learning model of environmental information and an estimation method using the learning model according to the first embodiment.

FIG. 4 is a flowchart illustrating live view display processing according to the first embodiment.

FIGS. 5A to 5D are diagrams illustrating a specific example of processing in a case where a virtual subject is superimposed on an image of wind blowing according to the first embodiment.

FIGS. 6A to 6D are diagrams illustrating a specific example of processing in a case where a virtual subject is superimposed on an image of rain falling according to the first embodiment.

FIGS. 7A to 7D are diagrams illustrating a specific example of processing in a case where a virtual subject is superimposed on an image of snow falling according to the first embodiment.

FIGS. 8A to 8D are diagrams illustrating a specific example of processing in a case where a virtual subject is superimposed on an image of a slope according to the first embodiment.

FIGS. 9A to 9D are diagrams illustrating a specific example of processing in a case where a virtual subject is superimposed on an image of a road with trees according to the first embodiment.

FIG. 10 is a flowchart illustrating live view display processing according to a second embodiment.

FIGS. 11A to 11C are diagrams illustrating a specific example of processing in a case where a virtual subject superimposed on an image including a puddle affects the image according to the second embodiment.

FIGS. 12A to 12C are diagrams illustrating a specific example of processing in a case where a virtual subject superimposed on an image including accumulated snow affects the image according to the second embodiment.

FIGS. 13A to 13C are diagrams illustrating a specific example of processing in a case where a virtual subject superimposed on an image including rain affects the image according to the second embodiment.

FIGS. 14A and 14B are conceptual diagrams of a generation method of a learning model of spatial information and an estimation method using the learning model according to a modification.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

First, a first embodiment of the present disclosure will be described.

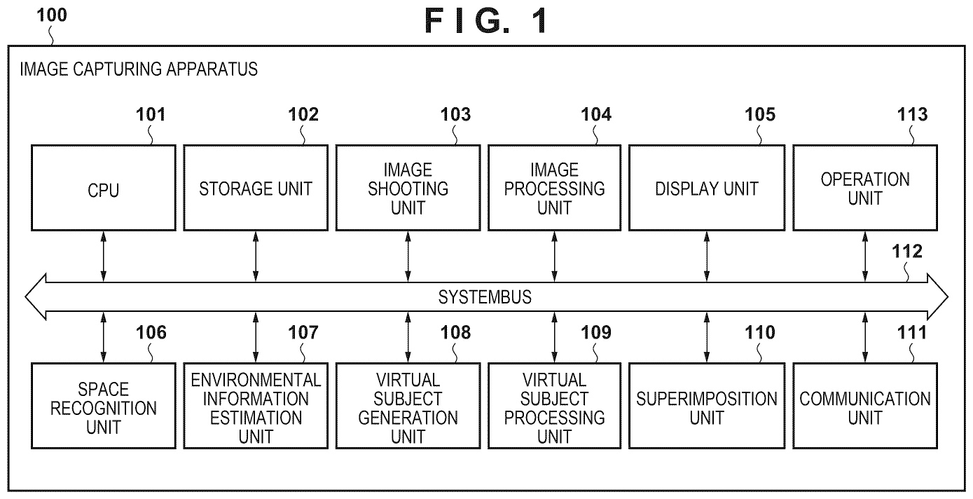

FIG. 1 is a block diagram illustrating an example of a functional configuration of an image capturing apparatus 100. As shown in FIG. 1, the image capturing apparatus 100 has a CPU 101, a storage unit 102, an image shooting unit 103, an image processing unit 104, a display unit 105, a space recognition unit 106, an environmental information estimation unit 107, a virtual subject generation unit 108, a virtual subject processing unit 109, a superimposition unit 110, a communication unit 111, an operation unit 113, and a system bus 112. In the following embodiment, a digital camera is used as an example of the image capturing apparatus 100, but the present disclosure can be applied to any electronic apparatuses that can be equipped with an image shooting function. Such electronic apparatuses include, for example, video cameras, computer apparatuses (personal computers, tablet computers, media players, PDAs, etc.), mobile phones, smartphones, game consoles, robots, drones, dashboard cameras, etc. These are examples, and the present disclosure can be applied to other electronic apparatuses.

The CPU 101 controls the entire image capturing apparatus 100, and executes programs stored in a ROM (not shown) to realize each process of the flowcharts described below.

The storage unit 102 is composed of a DRAM, a memory card, or the like, and records images generated by the image processing unit 104, as well as 3D objects and movement of the 3D objects received via the communication unit 111 in response to instructions from a user using the image capturing apparatus 100. A 3D object is a three-dimensional model defined in a file format such as OBJ or FBX. The recorded 3D object is used as a virtual subject in the virtual subject generation unit 108, which will be described later.

The image shooting unit 103 is composed of a lens unit, an image sensor, an A/D conversion circuit, etc., and performs a series of processes to capture images and output image signals. The image shooting unit 103 accepts the setting of shooting conditions such as aperture value, ISO sensitivity, exposure period, zoom magnification, and selection of focusing position.

The image processing unit 104 performs correction processing, encoding processing, etc. on the image signal obtained by the image shooting unit 103. The image processing unit 104 also generates images to be recorded and live view images from the image signal obtained from the image shooting unit 103.

The display unit 105 is composed of a liquid crystal display or an organic EL display, etc., and displays images generated by the image processing unit 104 or superimposed images generated by the superimposition unit 110 described later.

The communication unit 111 is an interface that connects the image capturing apparatus 100 to other apparatuses via wired or wireless means and transmits and receives 3D object data, image data, etc., and can also be connected to a network such as a wireless LAN or the Internet.

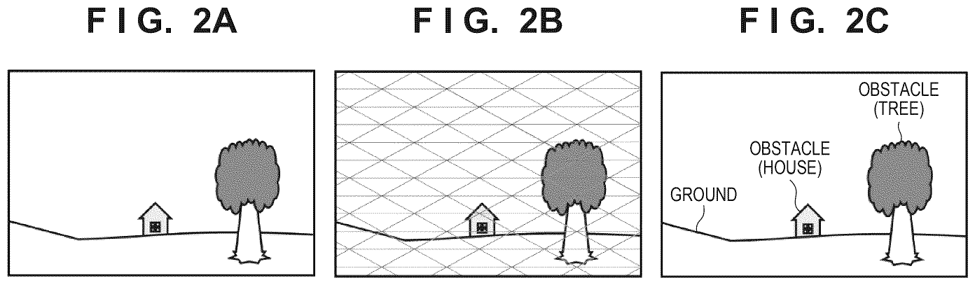

The space recognition unit 106 measures the space using, for example, Laser Imaging Detection and Ranging (LiDAR) technology to acquire spatial information on objects constituting the scene, such as terrain and obstacle positions in the area (scene) shot by the image capturing apparatus 100. As an example, in a case of acquiring spatial information using LiDAR, laser beams are irradiated as shown in FIG. 2B into a space as shown in FIG. 2A, and reflected light is detected to acquire spatial information such as the terrain and obstacles in the space, as shown in FIG. 2C. The spatial information includes terrain information such as the unevenness and inclination of the ground, and obstacle information such as the positions and sizes of obstacles.

The environmental information estimation unit 107 receives image data obtained by the image shooting unit 103 as an input, and estimates environmental information related to the environment of the scene being shot, including weather information such as wind, rain, or snow, contained in the image data, using a learning model stored in a ROM (not shown). When wind, rain, or snow is estimated, its location, direction, and amount are also estimated, and the weather information includes the estimated information.

The virtual subject generation unit 108 generates a virtual subject in response to the position, size, and orientation of the virtual subject designated by a user. The virtual subject can be specified, for example, by voice input, selection by GUI display on the display unit 105, designation via the operation unit 113, or image input via a network. The virtual subject is generated by selecting a 3D object stored in the storage unit 102 in response to the specification designated from the operation unit 113. In addition, the virtual subject may be generated by generating a 3D object using a machine learning model corresponding to the generation of a 3D object using the specification of the virtual subject as input, or by acquiring a 3D object from a network via the communication unit 111.

The virtual subject processing unit 109 processes the virtual subject generated by the virtual subject generation unit 108 according to the environmental information estimated by the environmental information estimation unit 107 and/or the spatial information acquired by the space recognition unit 106. The virtual subject is processed according to the environmental information and/or the spatial information (scene information) by inputting the virtual subject and the environmental information and/or the spatial information into a learning model.

For example, if the environmental information indicates rain, the learning model predicts the portion of the virtual subject which will get wet from the strength and direction of the rain, and the virtual subject's clothes and belongings are processed to look wet with water. If the environmental information indicates wind, the learning model predicts the portion of the virtual subject which will be blown by the wind and the effect on the virtual subject's posture based on the strength and direction of the wind, and the hair and clothes of the virtual subject are processed to look blown by the wind, and the virtual subject itself is processed to look like it is being blown by the wind. If the environmental information indicates snow, the learning model predicts the portion of the virtual subject where snow will accumulate from the amount and direction of snowfall, and the processing is performed such that snow accumulates on the top of the virtual subject.

In addition, in a case where the spatial information indicates the unevenness or inclination of the ground, the learning model estimates the angle at which the virtual subject will incline based on the unevenness or the magnitude of the inclination of the ground, and the virtual subject is processed to incline. In a case where the spatial information indicates existence of an obstacle, the learning model estimates the area in which the movement of the virtual subject is restricted by the obstacle based on the position and size of the obstacle, and the virtual subject is processed to move in a way that does not come into contact with the obstacle.

The superimposition unit 110 generates a superimposed image by superimposing the image data obtained by the image shooting unit 103 and the virtual subject processed by the virtual subject processing unit 109.

The operation unit 113 is used to allow the user to input various instructions, and consists of various operating members such as buttons, switches, a touch panel, a voice input unit, and a gaze detection unit, and so forth. The instructions input via the operation unit 113 are input to the CPU 101, and the CPU 101 performs processing based on the input instructions.

Each of the above-mentioned components is connected to the system bus 112, and can send and receive necessary data to and from each other via the system bus 112.

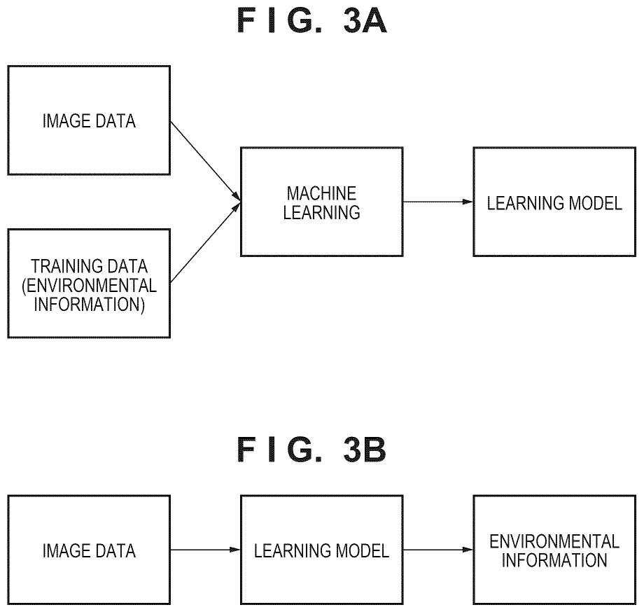

Next, the learning model and the method of estimating environmental information will be described with reference to FIGS. 3A and 3B.

As shown in FIG. 3A, the learning model is generated by performing supervised learning using image data and training data consisting of a set of ground truth data that is environmental information such as wind, rain, or snow contained in the corresponding image data. Specifically, learning is performed using a linear regression algorithm using the training data. Note that items used as ground truth data are not limited to these items. Also, other algorithms such as a K-nearest neighbor method or a neural network may be used in addition to linear regression algorithm.

As shown in FIG. 3B, the environmental information is estimated by inputting the image data into a learning model that has been trained using the environmental information as ground truth data, and the learning model estimates the environmental information included in the image data. Note that the input image data is image data captured by image capturing apparatus 100. In this embodiment, the environmental information obtained as the estimation result is wind, rain, snow, etc., contained in the image data.

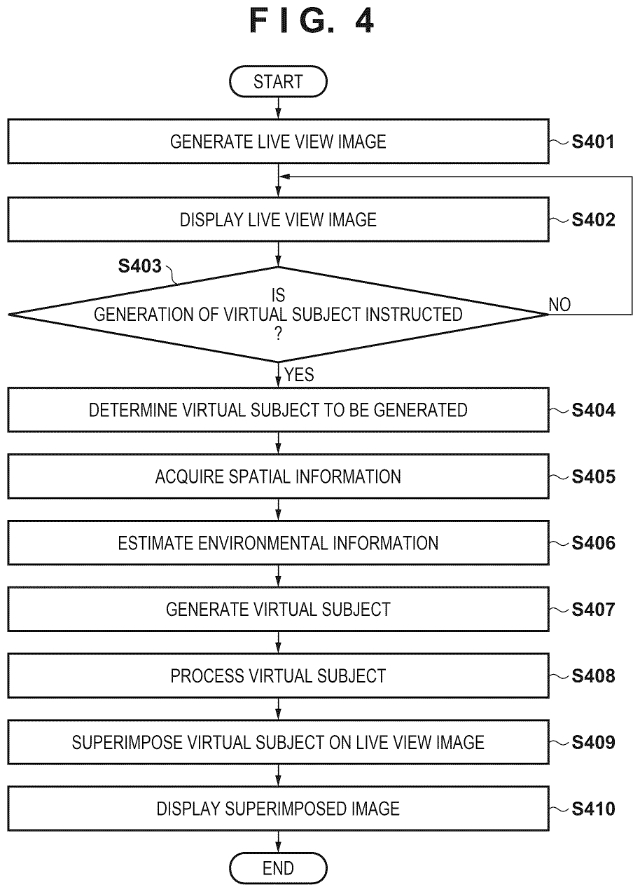

FIG. 4 is a flowchart showing the live view display processing in the image capturing apparatus 100 according to the first embodiment. The flowchart in FIG. 4 begins when the image capturing apparatus 100 is powered on.

In step S401, the image processing unit 104 generates a live view image from image data captured by the image shooting unit 103, and the process proceeds to step S402.

In step S402, the display unit 105 displays the live view image generated in step S401, and the process proceeds to step S403.

In step S403, the CPU 101 determines whether or not there is an instruction to generate a virtual subject from the user via the operation unit 113. If there is an instruction to generate a virtual subject, the process proceeds to step S404. If there is no instruction to generate a virtual subject, the process returns to step S402 and the display of the live view image continues.

In step S404, the virtual subject designated by the user via the operation unit 113 is determined as the virtual subject to be generated, and the process proceeds to step S405. The virtual subject designated here is, for example, a person or a car, and it is also possible to add characteristics or actions to the virtual subject, such as a person with long hair or a running car, as necessary.

In step S405, the space recognition unit 106 acquires spatial information of the area shot by image capturing apparatus 100, and the process proceeds to step S406.

In step S406, the environmental information estimation unit 107 estimates environmental information contained in the image data obtained in step S401, and the process proceeds to step S407.

In step S407, the virtual subject generation unit 108 generates the virtual subject designated in step S404, and the process proceeds to step S408.

Note that the order of the processes performed in steps S405, S406, and S407 may be changed, or may also be performed in parallel.

In step S408, the virtual subject processing unit 109 processes the virtual subject generated in step S407 by reflecting the spatial information acquired in step S405 and the environmental information estimated in step S406 to the virtual subject, and the process proceeds to step S409.

In step S409, the superimposition unit 110 generates a superimposed image by superimposing the virtual subject processed in step S408 on the live view image generated in step S401, and the process proceeds to step S410.

In step S410, the display unit 105 displays the superimposed image generated in step S409, and the processing ends.

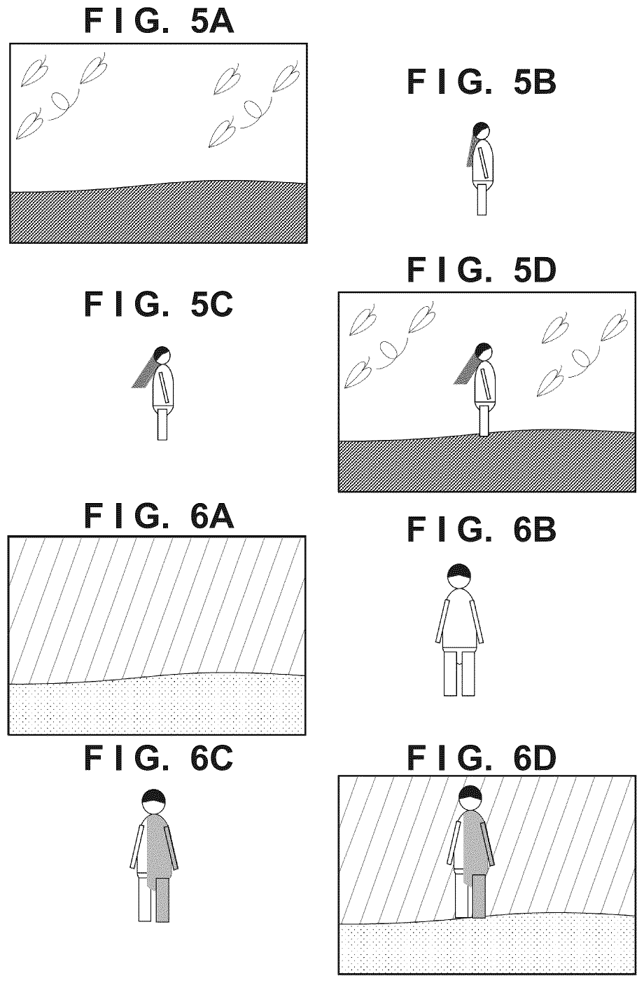

A specific example of the processing shown in FIG. 4 will be described below with reference to FIGS. 5A to 9D.

If the live view image displayed in step S402 is an image in which wind is blowing as shown in FIG. 5A, the environmental information estimated in step S406 is wind. If the virtual subject generated in step S407 is a person with long hair as shown in FIG. 5B, the virtual subject processed in step S408 will have the person's hair blowing as shown in FIG. 5C, and the superimposed image displayed in step S410 will be as shown in FIG. 5D.

Further, if the live view image displayed in step S402 is an image of rain as shown in FIG. 6A, the environmental information estimated in step S406 is rain. If the virtual subject generated in step S407 is a person as shown in FIG. 6B, the virtual subject processed in step S408 will have wet clothes as shown in FIG. 6C, and the superimposed image displayed in step S410 will be as shown in FIG. 6D.

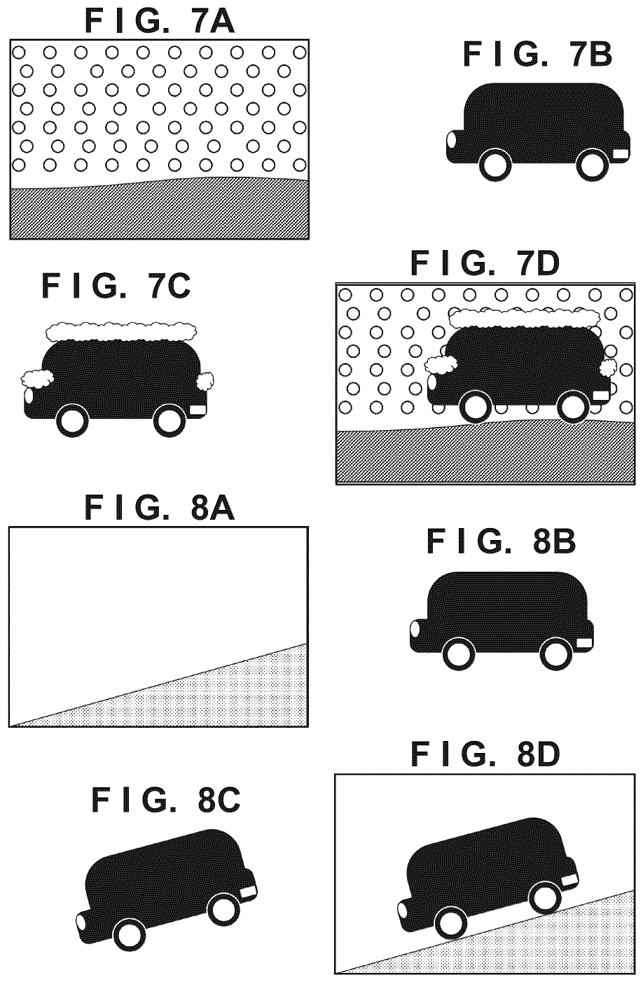

Moreover, if the live view image displayed in step S402 is an image of falling snow as shown in FIG. 7A, the environmental information estimated in step S406 is snow. If the virtual subject generated in step S407 is a car as shown in FIG. 7B, the virtual subject processed in step S408 will have snow piled up on the car as shown in FIG. 7C, and the superimposed image displayed in step S410 will be as shown in FIG. 7D.

Furthermore, if the live view image displayed in step S402 is an image of a slope as shown in FIG. 8A, the spatial information acquired in step S405 is the unevenness and inclination of the ground. If the virtual subject generated in step S407 is a car as shown in FIG. 8B, the virtual subject processed in step S408 will be a car that is inclined as shown in FIG. 8C, and the superimposed image displayed in step S410 will be as shown in FIG. 8D.

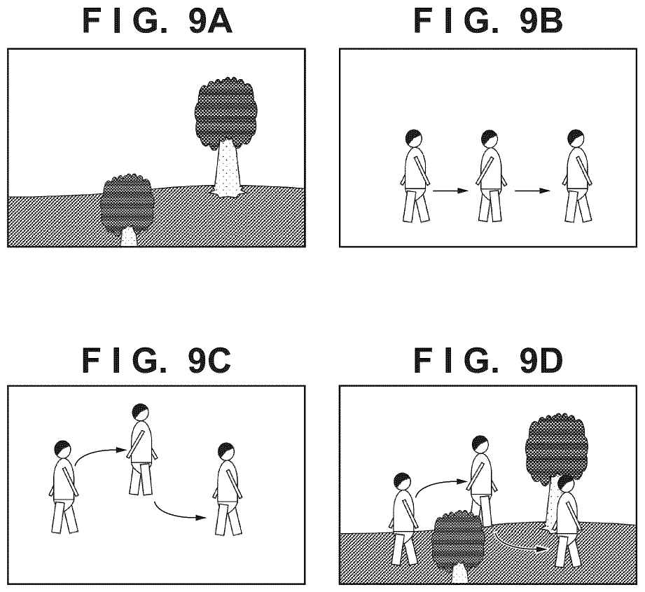

In addition, if the live view image displayed in step S402 is an image of a road with trees as shown in FIG. 9A, the spatial information acquired in step S405 is the positions and sizes of obstacles. If the virtual subject generated in step S407 is a walking person as shown in FIG. 9B, the virtual subject processed in step S408 will walk while avoiding the trees as shown in FIG. 9C, and the superimposed image displayed in step S410 will be as shown in FIG. 9D.

In the examples shown in FIGS. 5A to 9D, the cases where either environmental information or spatial information is reflected on the virtual subject are shown, but if both are reflected, the virtual subject may be processed as follows. For example, if snow is obtained as the environmental information and tilt is obtained as the spatial information, the virtual subject is processed such that, on a car shown in FIG. 8D, snow is piled up as shown in FIG. 7D. In this way, in a case where a plurality of pieces of environmental information and spatial information are obtained, the virtual subject is processed in step S408 according to each piece of information.

As described above, according to the first embodiment, a virtual subject on which environmental information and/or spatial information of the real space is reflected is generated, and a superimposed image that is consistent with the real space is generated and displayed as a live view image, making it possible to consider the angle of view and composition under conditions that are close to reality.

In the first embodiment, the spatial information and the environmental information are described as being acquired, but it is also possible to acquire one of them and process the virtual subject based on the acquired information. Even in that case, it is possible to generate a more natural superimposed image compared to the conventional method.

### Second Embodiment

A second embodiment of the present disclosure will be described below. Note that an image capturing apparatus in the second embodiment can have a configuration similar to that of the image capturing apparatus 100 described in the first embodiment with reference to FIG. 1, so a description thereof will be omitted here.

However, the superimposition unit 110 in the second embodiment not only generates a superimposed image by superimposing a virtual subject processed by the virtual subject processing unit 109 on the image data captured by the image shooting unit 103, but also estimates the influence of the virtual subject on the image data using a learning model and performs processing to reflect the influence on the image data before superimposing the image data and the virtual subject. The estimation of the influence of the virtual subject on the image data is performed by inputting the image data and the virtual subject into the learning model.

The effect of a virtual subject on image data is a phenomenon that is considered to occur due to the action of a virtual subject in real space, such as the phenomenon of a virtual subject being reflected on image data in a case where there is a reflective object such as glass, a mirror, or the surface of water, or the phenomenon in which the shape of snow or the surface of water is changed by the presence of a virtual subject.

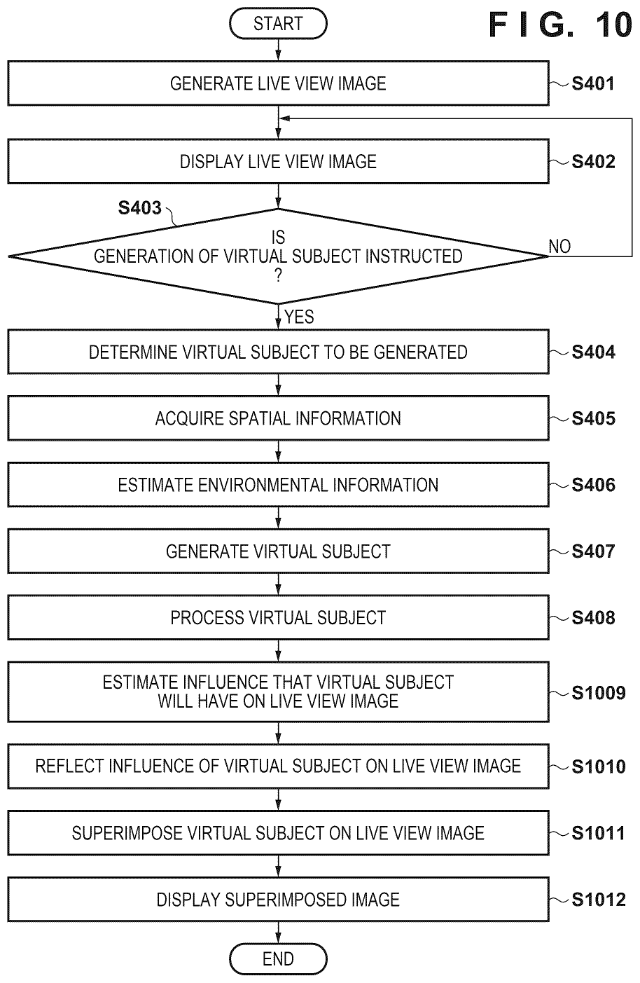

FIG. 10 is a flowchart showing a live view display processing in the image capturing apparatus 100 according to the second embodiment. Note that in FIG. 10, the same processes as those shown in FIG. 4 are denoted by the same reference numerals, and descriptions thereof will be omitted as appropriate.

In step S408, the virtual subject is processed based on the spatial information acquired in step S405 and the environmental information estimated in step S406, and then in the next step S1009, the superimposition unit 110 estimates the influence that the virtual subject processed in step S408 will have on the live view image, and the process proceeds to step S1010.

In step S1010, the superimposition unit 110 reflects the influence on the live view image estimated in step S1009 on the live view image, and the process proceeds to step S1011.

In step S1011, the superimposition unit 110 generates a superimposed image by superimposing the virtual subject processed in step S408 on the live view image on which the influence of the virtual subject is reflected in step S1010, and the process proceeds to step S1012.

In step S1012, the display unit 105 displays the superimposed image generated in step S1011, and the process ends.

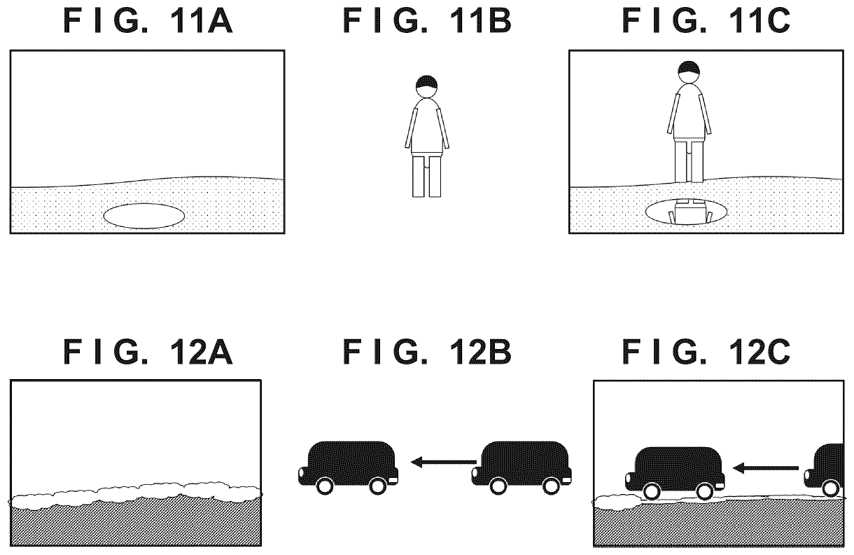

A specific example of the processing shown in FIG. 10 will be described below with reference to FIGS. 11A to 13C.

If the live view image displayed in step S402 includes a puddle as shown in FIG. 11A, and the virtual subject generated in step S407 is a person as shown in FIG. 11B, in step S1009, a reflection image reflected on the puddle is estimated using a learning model based on the distance between the puddle and the virtual subject and the position of the light source, and in step S1010, the reflection image is reflected in the image data so that the reflection image of the virtual subject is drawn in the puddle in the image data. Then, in step S1011, the virtual subject processed in step S408 is superimposed on the image data in which the reflected image is drawn. The superimposed image obtained in this way and displayed in step S1012 is an image in which the reflection image of the generated person is reflected in the puddle as shown in FIG. 11C.

Furthermore, if the live view image displayed in step S402 includes accumulated snow as shown in FIG. 12A and the virtual subject generated in step S407 is a moving car as shown in FIG. 12B, then in step S1009, the snow that will be crushed by the virtual subject is predicted using a learning model, and in step S1010, this is reflected in the image data so that some of the accumulated snow in the image is crushed. Then, in step S1011, the virtual subject processed in step S408 is superimposed on the image data in which some of the snow is crushed. The superimposed image thus obtained and displayed in step S1012 is an image in which the snow has been crushed in areas where the car has passed, as shown in FIG. 12C.

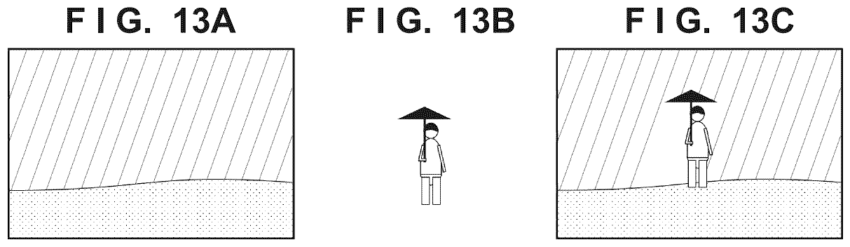

Furthermore, if the live view image displayed in step S402 includes rain as shown in FIG. 13A and the virtual subject generated in step S407 is a person holding an umbrella as shown in FIG. 13B, in step S1009, the area in which the virtual subject blocks the rain is estimated using a learning model based on the direction of the rain, and in step S1010, this is reflected in the image data so that rain does not fall behind the virtual subject. Then, in step S1011, the virtual subject processed in step S408 is superimposed on the image data in which rain is not falling behind the virtual subject. The superimposed image thus obtained and displayed in step S1012 is an image in which rain is not falling under the umbrella held by the person, as shown in FIG. 13C.

As described above, according to the second embodiment, in a case where an image of a real space on which a virtual subject is superimposed is to be generated, the influence of the virtual subject on the real space is estimated and reflected, thereby making it possible to generate a superimposed image in which consistency between the real space and the virtual subject is held. This makes it possible to consider the angle of view and composition under conditions close to reality.

### Modification

In the first and second embodiments described above, the space recognition unit 106 has been described as acquiring spatial information such as the terrain of the space and the positions of obstacles, for example, using LiDAR.

In contrast, in the modified example, the space recognition unit 106, like the environmental information estimation unit 107, uses a learning model to acquire spatial information in image data.

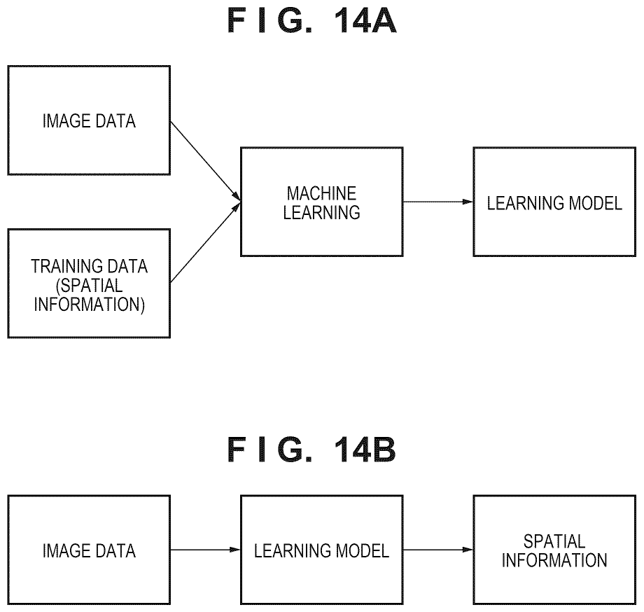

As shown in FIG. 14A, the learning model used to acquire spatial information is generated by performing supervised learning using training data consisting of a set of image data and ground truth data, which is spatial information such as terrain and obstacles in the corresponding image data. Specifically, learning is performed using a linear regression algorithm with the training data. Note that items used as ground truth data are not limited to these items. Also, other algorithms such as K-nearest neighbors algorithm and neural networks may be used in addition to linear regression algorithm.

As shown in FIG. 14B, the environmental information is estimated by inputting the image data into a learning model that has been trained using spatial information as ground truth data, and having the learning model estimate the spatial information contained in the image data. Note that the image data to be input is image data captured by the image capturing apparatus 100. In this embodiment, the spatial information obtained as an estimation result is the terrain, obstacles, etc. in the image data.

In this modification, in step S405 in FIG. 4 or FIG. 10, the space recognition unit 106 acquires spatial information obtained using the learning model, and thereafter performs the same processing as that described in the first and second embodiments. As a result, in this modification as well, the same effects as those in the first and second embodiments can be obtained. In addition, since a light emitting member for irradiating laser beams and a detection member for detecting reflected light are not required, the configuration of the image capturing apparatus 100 can be simplified.

### OTHER EMBODIMENTS

The present disclosure may be applied to a system made up of a plurality of devices, or to an apparatus made up of a single device.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-102222, filed Jun. 25, 2024 which is hereby incorporated by reference herein in its entirety.

What is claimed is:

1. An image processing apparatus comprising one or more processors and/or circuitry which function as:
an acquisition unit that acquires scene information of a scene being captured by an image capturing unit;
a generation unit that generates a virtual subject;
a processing unit that processes the virtual subject based on the scene information; and
a superimposing unit that superimposes the virtual subject processed by the processing unit onto image data of the scene obtained from the image capturing unit.

2. The image processing apparatus according to claim 1, wherein the acquisition unit estimates the scene information of the image data of the scene obtained from the image capturing unit using a learning model trained using image data and the scene information.

3. The image processing apparatus according to claim 2, wherein
the acquisition unit estimates, as the scene information, at least one of environmental information about environment of the scene and spatial information about objects that constitute the scene, and
the processing unit processes the virtual subject based on at least one of the environmental information and the spatial information.

4. The image processing apparatus according to claim 1, wherein
the scene information includes at least one of environmental information about environment of the scene and spatial information about objects that constitute the scene, and
the acquisition unit includes at least one of:
an estimation unit that estimates the environmental information of the image data of the scene obtained from the image capturing unit using a learning model trained using image data and the environmental information, and
a detection unit that measures a space of the scene to acquire spatial information, and
the processing unit processes the virtual subject based on at least one of the environmental information and the spatial information.

5. The image processing apparatus according to claim 4, wherein the detection unit measures the space of the scene by irradiating laser beams into the space and detecting reflected light.

6. The image processing apparatus according to claim 3, wherein the environmental information includes weather information.

7. The image processing apparatus according to claim 6, wherein
the weather information includes information relating to a position, direction, and amount of at least one of wind, rain, and snow, and
the processing unit reflects, on the virtual subject, an effect of at least one of the wind, rain, and snow that affects the virtual subject.

8. The image processing apparatus according to claim 4, wherein the environmental information includes weather information.

9. The image processing apparatus according to claim 8, wherein
the weather information includes information relating to a position, direction, and amount of at least one of wind, rain, and snow, and
the processing unit reflects, on the virtual subject, an effect of at least one of the wind, rain, and snow that affects the virtual subject.

10. The image processing apparatus according to claim 3, wherein the spatial information includes at least one of terrain information and obstacle information.

11. The image processing apparatus according to claim 10, wherein
the terrain information includes information about at least one of unevenness of ground and inclination of ground, and
the processing unit reflects, on the virtual subject, an effect of at least one of the unevenness of ground and the inclination of ground that affects the virtual subject.

12. The image processing apparatus according to claim 10, wherein
the obstacle information includes information about at least one of a position and a size of the obstacle, and
the processing unit reflects, on the virtual subject, an effect of the obstacle that affects the virtual subject.

13. The image processing apparatus according to claim 4, wherein the spatial information includes at least one of terrain information and obstacle information.

14. The image processing apparatus according to claim 13, wherein
the terrain information includes information about at least one of unevenness of ground and inclination of ground, and
the processing unit reflects, on the virtual subject, an effect of at least one of the unevenness of ground and the inclination of ground that affects the virtual subject.

15. The image processing apparatus according to claim 13, wherein
the obstacle information includes information about at least one of a position and a size of the obstacle, and
the processing unit reflects, on the virtual subject, an effect of the obstacle that affects the virtual subject.

16. The image processing apparatus according to claim 1, wherein
the one or more processors and/or circuitry further function as an estimation unit that estimates an influence of the virtual subject on the scene in a case where the virtual subject is superimposed on image data of the scene by the superimposing unit, and
the superimposing unit superimposes the virtual subject processed by the processing unit on the image data processed based on the influence estimated by the estimation unit.

17. The image processing apparatus according to claim 1, further comprising a display unit that displays the image data obtained by the superimposing unit performing superimposition.

18. An image capturing apparatus comprising:
an image processing apparatus comprising one or more processors and/or circuitry which function as:
an acquisition unit that acquires scene information of a scene being captured by an image capturing unit;
a generation unit that generates a virtual subject;
a processing unit that processes the virtual subject based on the scene information; and
a superimposing unit that superimposes the virtual subject processed by the processing unit onto image data of the scene obtained from the image capturing unit; and
the image capturing unit.

19. An image processing method comprising:
acquiring scene information of a scene being captured by an image capturing unit;
generating a virtual subject;
processing the virtual subject based on the scene information; and
superimposing the processed virtual subject onto image data of the scene obtained from the image capturing unit.

20. A non-transitory computer-readable storage medium, the storage medium storing a program that is executable by the computer, wherein the program includes program code for causing the computer to function as an image processing apparatus comprising:
an acquisition unit that acquires scene information of a scene being captured by an image capturing unit;
a generation unit that generates a virtual subject;
a processing unit that processes the virtual subject based on the scene information; and
a superimposing unit that superimposes the virtual subject processed by the processing unit onto image data of the scene obtained from the image capturing unit.
